(19) United States
(12) Patent Application Publication
(10) Pub. No.: US 2024/0377932 A1
(43) Pub. Date: Nov. 14, 2024

(54) LANGUAGE MODEL ASSISTANCE PROVIDED BY AN OPERATING SYSTEM

(71) Applicant: GOOGLE LLC, Mountain View, CA (US)

(72) Inventors: Guoxing Zhao, South Hurstville (AU); Curtis William McMullan, Sydney (AU); Dac Thanh Chuong Ho, Marrickville (AU); Mehrab Norouzitallab, St. Leonards (AU); Robert Schonberger, Clovelly (AU); Yuncheng Shen, Sunnyvale, CA (US); Zachary Webb Partridge, Lilyfield (AU); David-Jordi Vallet Weadon, Leichhardt (AU); Omri Amarilio, Palo Alto, CA (US)

(21) Appl. No.: 18/660,194

(22) Filed: May 9, 2024

Related U.S. Application Data
(60) Provisional application No. 63/501,100, filed on May 9, 2023.

(51) Int. Cl. G06F 3/04842; G06F 40/40

(52) U.S. Cl. CPC G06F 3/04842; G06F 40/40

(57) ABSTRACT

A method may receive a selection of content. A method may, in response to receiving the selection, providing a prompt based on the selection and context relating to the selection. A method may display the prompt. A method may, in response to receiving a selection of the prompt, generating output by providing the content and the prompt as input to a language model. A method may display the output.

### CROSS REFERENCE TO RELATED APPLICATION

This application claims the benefit of U.S. Provisional Application No. 63/501,100, filed May 9, 2023, the disclosure of which is incorporated herein by reference in its entirety.

### BACKGROUND

Presently, there are numerous applications that help a user interact with text and content, such as word processor, messaging, and emailing applications to name a few. Some applications suggest corrections to misspellings and/or small phrases within a longer text or offer small snippets of predictive text as a user types. Other applications provide access to generative language models for users, who must provide prompts and context to the models.

### SUMMARY

The disclosure describes methods to provide assistance for accessing and using generative language model tools within an operating system environment to help a user create content, modify content, and obtain explanations for content, without leaving the application window (i.e., without the application window losing focus) and regardless of whether the application itself supports such tools. Upon selecting content in an application window, one or more prompts are determined and caused to be displayed. In one example, the prompts are generated based on the selected content and context relating to the selection. Other information available via the application or the operating system may also be used to generate the prompt. Once an input that is a selection of the prompt is received, one or more outputs may be generated using the generative language model. When a user selects an output, they may be presented with further prompts to revise the content may be generated and presented. In another example, upon receiving a selection of content in the application, prompts to provide explanations of the selected content may be generated and displayed.

In some aspects, the techniques described herein relate to a method including: receiving a selection of content; in response to receiving the selection, providing a prompt based on the selection and context relating to the selection; displaying the prompt; in response to receiving a selection of the prompt, generating output by providing the content and the prompt as input to a language model; and displaying the output.

In some aspects, the techniques described herein relate to a method including: receiving a selection of content; in response to receiving the selection of the content, displaying an option for generating an explanation of the selection; generating the explanation by providing the selection of content and the option as input to a language model; and displaying the explanation.

In some aspects, the techniques described herein relate to a system including: a processor; and a memory configured with instructions to: receive a selection of content; in response to receiving the selection, provide a prompt based on the selection and context relating to the selection; display the prompt; in response to receiving a selection of the prompt, generate output by providing the content and the prompt as input to a language model; and display the output.

In some aspects, the techniques described herein relate to a system including: a processor; and a memory configured with instructions to: receive a selection of content; in response to receiving the selection of the content, display an option for generating an explanation of the selection; generate the explanation by providing the selection of content and the option as input to a language model; and display the explanation.

In some aspects, the techniques described herein relate to a computing device, including: at least one processor; and a non-transitory computer-readable medium storing executable instructions that, when executed by the at least one processor, cause the computing device to: receive a selection of content; in response to receiving the selection, provide a prompt based on the selection and context relating to the selection; display the prompt; in response to receiving a selection of the prompt, generate output by providing the content and the prompt as input to a language model; and display the output.

### BRIEF DESCRIPTION OF THE DRAWINGS

FIG. 1A depicts a window in accordance with an example.

FIG. 1B depicts a window in accordance with an example.

FIG. 1C depicts a window in accordance with an example.

FIG. 1D depicts a window in accordance with an example.

FIG. 2 depicts a system in accordance with an example.

FIG. 3A depicts a window in accordance with an example.

FIG. 3B depicts a window in accordance with an example.

FIG. 4A depicts a window in accordance with an example.

FIG. 4B depicts a window in accordance with an example.

FIG. 4C depicts a window in accordance with an example.

FIG. 4D depicts a window in accordance with an example.

FIG. 5A depicts a menu in accordance with an example.

FIG. 5B depicts a menu in accordance with an example.

FIG. 5C depicts a menu in accordance with an example.

FIG. 6A depicts a method in accordance with an example.

FIG. 6B depicts a method in accordance with an example.

### DETAILED DESCRIPTION

Generating clear, meaningful content and communications takes a lot of user time and effort. There are newly available language models that a user may prompt to automatically generate content. In order to get helpful output from the language model, however, a user needs to be skilled at designing prompts for the model. In addition, the new language model-based tools are often accessed in standalone applications outside the context of other tools or applications that a user is using.

A language model (e.g., generative language model) is a type of machine-learning model that uses deep learning to generate human-like text or speech based on a prompt. Language models are trained on vast amounts of data, typically in the form of text or speech, and can use this data to predict text outputs. Typically, language models execute on a server.

Prompts for language models may include instructions, questions, or any other type of input, depending on the intended use of the model. The prompt may comprise a question that the user wishes to answer by executing the language model, such as what is the definition of this word?

Prompt context can be provided with a prompt to the language model to generate an output. Prompt context can be any data (e.g., text, an image file, an audio file, an embedding, etc.) that helps the language model better interpret the prompt and/or generate a more accurate answer. The prompt context can include data representing the result of prior rounds or turns with the model (e.g., a prior prompt and the prior response generated by the model). The prompt context provided with the prompt is not typically provided by the user.

Window context, for the purposes of this disclosure, includes any data that describes the setting in which assistance from a large language model is requested, including content of the application window that currently has focus. This window context can represent content in the application window that appears near a selection of content. The window context can represent, with user permission, preferences or attributes from a user profile. The window context can represent, with user permission, data obtained from the operating system environment, Where the application window includes a browser window, the window context can include data describing a source (domain) associated with the window. The window context can include data describing an editable user interface element (e.g., maximum character length of a text box). The example of a text content is used in this disclosure, but that is not intended to be limiting. In further examples, any type of content may be used as window content.

It is a technical problem that the quality of a language model output depends on the quality of the prompt used as input. Few users are knowledgeable about how to prompt a language model to generate a valuable output, however. Therefore, users sometimes give up on generating content with a language model tool after one or two prompts and fail to leverage the full power of language models to boost their productivity.

A further technical problem with using language models is that the outputs they provide are dependent on the quality of the context provided to the model. But prompt context is conventionally not provided by users. Even where a user can provide window context, doing so would require knowledge on behalf of the user, however, who might not understand what window context may be helpful to the model or where to find it.

The present disclosure provides technical solutions that include using additional data available on a user device (context for the application and/or the operating system environment, referred to as device context) to generate more targeted prompts. The disclosure further describes using additional data available on the user device, i.e., at least a portion of the device context, as prompt context (context provided to the language model) to improve the quality of language model outputs. Finally, the disclosure describes executing a language model on a user device so that window context can be used while respecting privacy. Each of these technical solutions may improve human-machine interactions by reducing the steps needed to accomplish a task and to improve the quality of outputs generated by the language model.

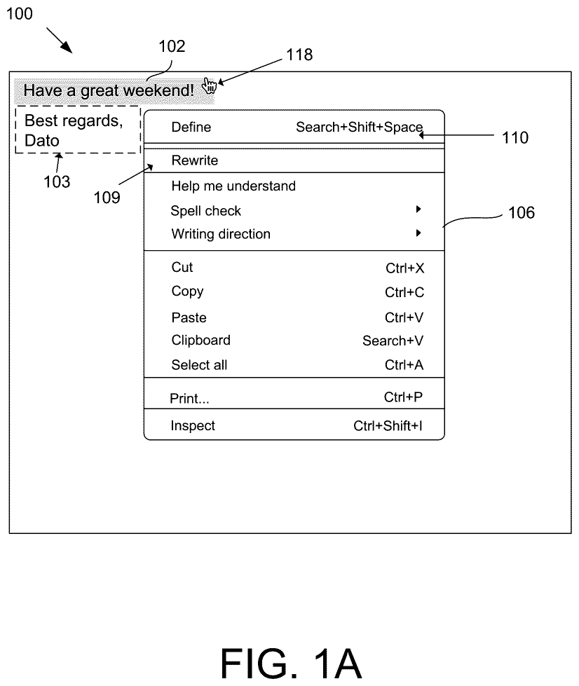

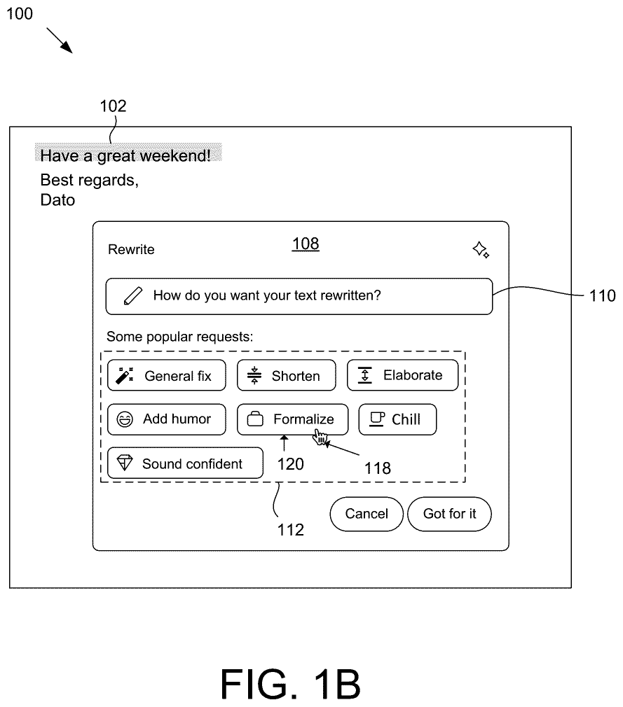

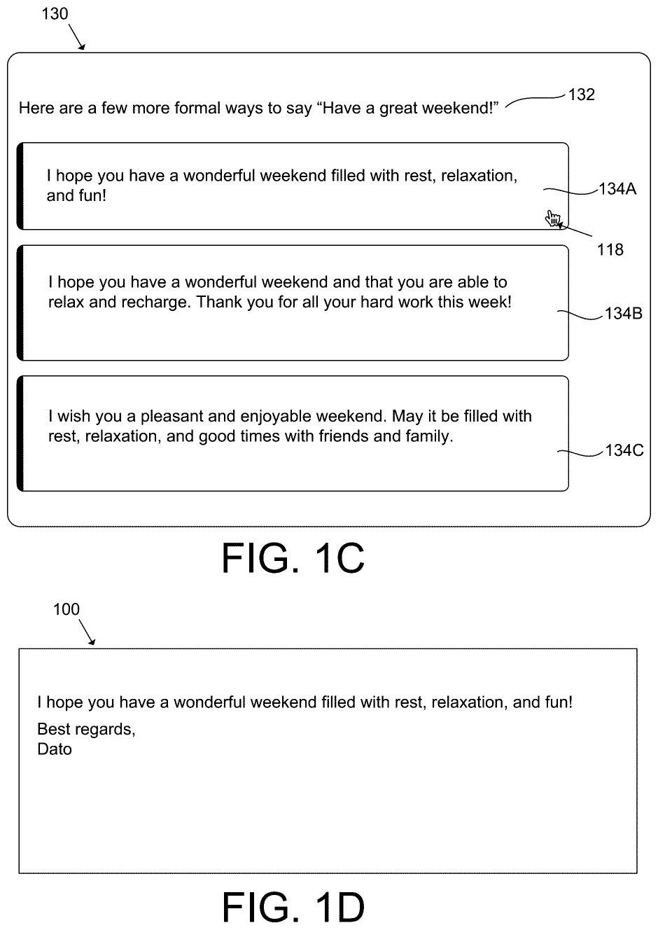

FIGS. 1A and 1B depict an application window 100 with content for an email application. In the example, a user has drafted an email and highlighted a portion of it so that the draft email includes both selected content 102 and unselected content 103. Methods described herein may provide a prompt to generate content with a language model (e.g., prompt suggestion section 112 in menu 108). The prompt may be provided based on the selected content 102 and further window context. The further window context can include the unselected content 103. The further window context can relate to the application (e.g., an email application, a title or domain of the application, etc.). Methods described herein may further provide for an option to generate an explanation of the selected content 102 via a language model as well.

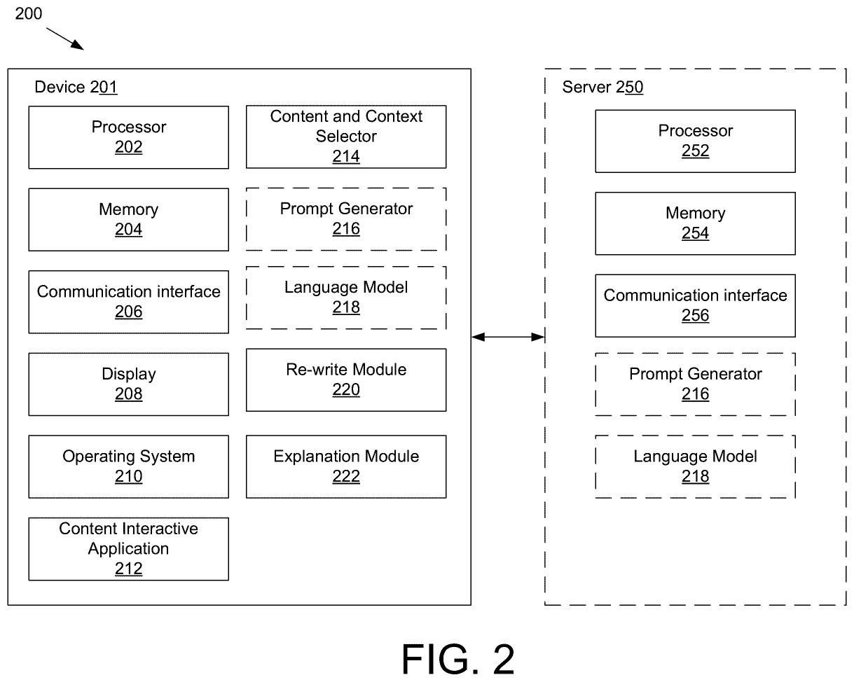

FIG. 2 depicts system 200, according to an example. The system 200 includes a device 201. In examples, the system 200 may further include a server 250. The device 201 may be used by an end user seeking to generate, modify, or learn more about content when using an application that displays and/or allows a user to interact with content (e.g., text). In examples, the device 201 may be a desktop or laptop computer, a handheld computer, a tablet, a smart phone, or any other type of user device.

Further to the descriptions below, a user may be provided with controls elect both if and when systems, programs, or features described herein may enable use of data from the device 201, including user information (e.g., information about a user's computing activities, a user's preferences, information about a user's data), to create prompts and identify context that can be used to generate outputs from a language model. Some data may be treated in one or more ways before it is used so that personally identifiable information is removed. In this way, the user may have control over what information from the device 201 is used, how that information is used, and what information, if any, is sent to a server.

The device 201 includes a processor 202, a memory 204, a communication interface 206, a display 208, an operating system 210, an interactive content application 212, a context selector 214, a prompt generator 216, a language model 218, a re-write module 220, and an explanation module 222.

The server 250 may include a processor, 252, a memory 254, a communication interface 256. The server 250 may further include any combination of content and context selector 214, the prompt generator 216 and/or the language model 218.

The device 201 includes the processor 202 and the memory 204. The processor 202 may include multiple processors, and memory 204 may include multiple memories. Processor 202 may be configured by instructions to generate the starting interface described in the disclosure. The instructions may include non-transitory computer-readable instructions stored in, and recalled from, memory 204.

The device 201 includes the memory 204, which may include code to operate any combination of the operating system 210, the interactive content application 212, the content and context selector 214, the prompt generator 216, the language model 218, the re-write module 220, and/or the explanation module 222.

The communication interface 206 of device 201 may be operable to facilitate communication between device 201 and server 250 or any other computing device. In examples, communication interface 206 may utilize short-range wireless communication protocols, such as BLUETOOTH, Wi-Fi, Zigbee™, or any other wireless or wired communication methods.

In examples, the processor 252, the memory 254 and the communication interface 256 of the server 250 may include similar features to the processor 202, the memory 204 and the communication interface 206, respectively.

The display 208 of the device 201 may comprise any type of display internal or external to computing device 201. The processor 202 may render graphics for display on the display 208.

The operating system 210 may execute on the processor 202, providing a platform for other applications to execute. In examples, the operating system 210 may be a browser-based operating system.

The processor 202 may include the interactive content application 212. The interactive content application 212 displays content. The interactive content application 212 may further allow a user to do any combination of interacting with content via creating, modifying, saving, or sending content. In examples, the interactive content application 212 may be a native application or a browser application. In examples, the interactive content application 212 may be a browser application, a word processing application, a productivity application, a messaging application, an email application, or any other type of application or program. In the example where the interactive content application 212 is a native application, it may retrieve and save data from the memory 204.

In the example where interactive content application 212 is a browser application, it may retrieve web pages from remote servers that host webpages and internet-based applications. The browser may be configured to display webpages, execute web applications (e.g., applications executing in a browser tab), and the like. The browser may include additional functionality in the form of browser extensions, e.g., a browser plug-in. The browser may access a browser history. The browser may receive content from a URL that includes displayable content and non-displayable content that includes metadata. Metadata may include any data in a document displayed in a browser that is not displayed.

The interactive content application 212 may include a window with content displayed. For example, FIG. 1A depicts a window 100 with content 102 displayed. The example application of FIG. 1A is an email application, and the content 102 in the example is the text string, “Have a great weekend”. This is not intended to be limiting, however. In examples, any type of interactive content application and content are contemplated.

The processor 202 may further include content and context selector 214. In examples, content and context selector 214 may receive content from application window 100, a URL rendered on application window 100, the application rendering application window 100, other applications executing on the operating system 210, the operating system 210, or data files stored on the memory 204.

Content and context selector 214 may receive content and/or window context associated with the application window 100 to provide to the language model 218. In examples, window context may include content from the window excluded from the selection. In examples, the window content may include any combination of text, image, audio data, associated metadata, or other data.

In examples, content and context selector 214 may include a set of user settings operable to determine what window context may be used as an input to the language model 218.

In examples, content and context selector 214 may receive selected content associated with the application window 100. An indication may be received that a user has selected content displayed in a window. In examples, the selection of content may be editable and used to generate an output that is replacement content for the selection. Replacement content is content generated by the language model intended to replace the selected content associated with the application window 100. In further examples, the selection of content may be read-only. In other words, the content may not be changed or edited by a user of the device 201 in the window 100. In examples, the content may be text or an image. In examples, the indication may comprise an event notification that a user has highlighted a section of text displayed. In examples, the indication may comprise an event notification that a user has hovered a mouse over a section of text (or an image), or any other method of determining that a user is selecting or is likely to select text soon. In some implementations, selected content 402 may be selected via a smart or predictive selection process.

For example, in FIG. 1A, a user has selected a selected content 102, “Have a great weekend!”, which is the body of an email. In examples, selected content 102 may be selected by hovering a cursor 118 over the text. In examples, selected content 102 may be selected by highlighting the text, selecting text, or via any other methods. In some implementations, selected content 102 may be selected via a smart or predictive selection process.

In examples, with user consent, content and context selector 214 may receive content and window context. For example, FIG. 1A depicts unselected content 103, which includes the text “Best regards, Dato”, the closing of an email. In examples, the unselected content 103 may include text, image, audio, semantic relationships, or metadata present in the documents displayed in application window 100. In examples, with user consent, the window context may include any combination of prior prompt selections made by the user, prior outputs from the language model, information about a website where selected content 102 is displayed, search queries a user has performed, links present in an email message, and so forth.

In examples, with user consent, the context selector 214 may identify additional information for input to the language model 218, including data about background or user actions preceding the selection of a prompt. The additional information may include other information relating to the interactive content application 212, the operating system 210, browser history, or data available on the device 201. In examples, additional information may include one or more applications executing on the device 201. For example, content and context selector 214 may determine what applications and/or processes may be executing via an application programing interface (API).

In examples, the context selector 214 may identify content displayed or open on other applications. For example, if the selected content 102 is within an email application, the context selector 214 may identify as window content a URL or a photo displayed in a browser application.

In examples, the processor 202 may include the prompt generator 216. The prompt generator 216 may identify a prompt to provide as an input to the language model 218.

Turning to FIG. 1A, it may be seen that the prompt generator 216 may display a menu 106 including one or more prompts for the user. In an example, the menu 106 may be displayed upon highlighting selected content 102 and/or right clicking. The menu 106 may include several options that a user may select to further interact with the selected content 102, including a rewrite option 109. The prompts available via the rewrite option 109 on the menu 106 may provide an output that is a revised version (e.g., a rewrite) of the selected content 102.

In FIG. 1B, the rewrite option 109 has been selected and a further menu 108 is displayed to allow the user to further refine the prompt. In an example, the prompt entry box 110 may allow a user to enter a custom prompt. In an example, a prompt suggestion section 112 may surface one or more suggested prompts for the user to select to revise the selected content 102. In the example, one or more suggested prompts in the prompt suggestion section 112 may include, “Elaborate”, “Shorten”, and “Add humor”. In another example, one or more suggested prompts may include prompts to interpret or further understand the selected content 102. In one example, suggested prompts can be obtained from a model. For example, the system may call a model with the prompt of “provide additional suggestions for understanding [selected content]” and context of the currently running application, resource location (e.g., URL), other screen content, etc. and the model (e.g., a language model) may provide suggested prompts. As another example, suggested prompts can be based on a variety of factors. The factors can include popularity (e.g., which prompts have been determined to be requested frequently given the context). The factors can include, with user consent, personalized factors, such as prompts the user has previously selected. The factors can include operating system factors, such as which application is running, what other applications are running, etc. The factors can include what was selected or the window context around what was selected. The factors may further include, with user consent, applications that a user uses and patterns and historical actions taken by a user. Example prompts not illustrated in FIG. 1B include ‘create an image for [selected content 102]’ or ‘describe what is pictured in [selected image]’.

In examples, the prompt suggestion section 112 may surface prompts based on the popularity of those prompts given a particular context. For example, the prompt suggestion section 112 provides options for a user to shorten or elaborate on the selected content 102.

In an example, the prompt generator 216 may surface a prompt based on the selected content 102 and/or window context. For example, if a body of a letter is selected, the prompt generator 216 may offer to formalize the letter.

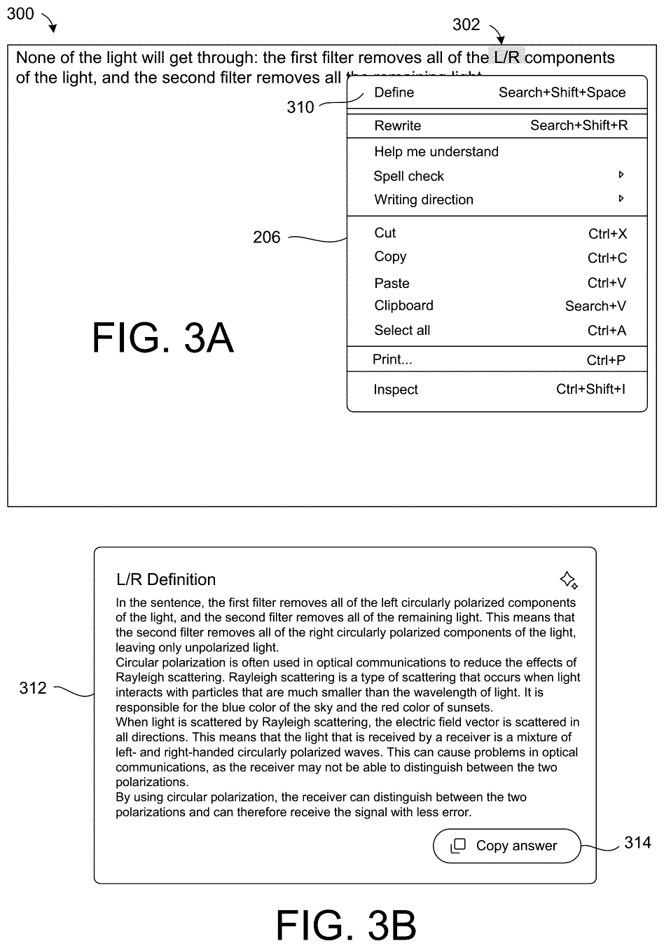

In an example, the prompt generator 216 may offer a prompt to provide an explanation of the selected content 302, such as a definition for a term. For example, FIG. 3A depicts an example word processing application window 300. A user has selected a term from content displayed in the word processing application window 300, a selected content 302 (“L/R”), and right clicked to initiate the display of the menu 106. The menu 106 includes a define prompt 310. Upon selecting the define prompt 310, a definition output window 312 may be displayed over the word processing application window 300.

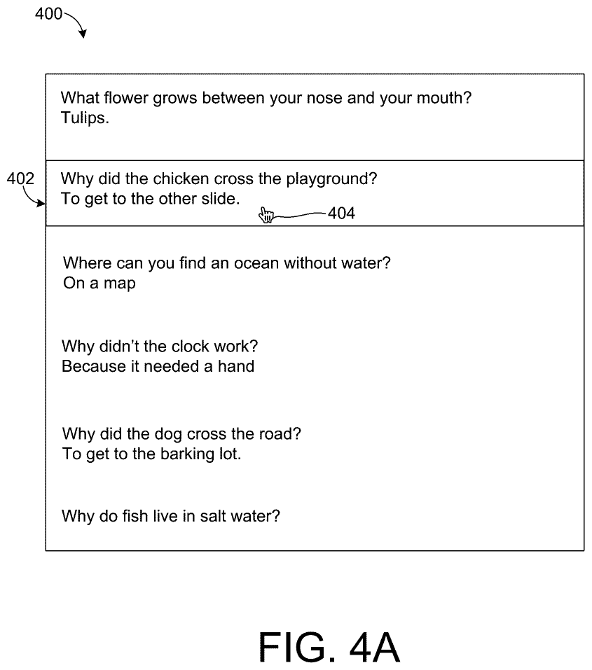

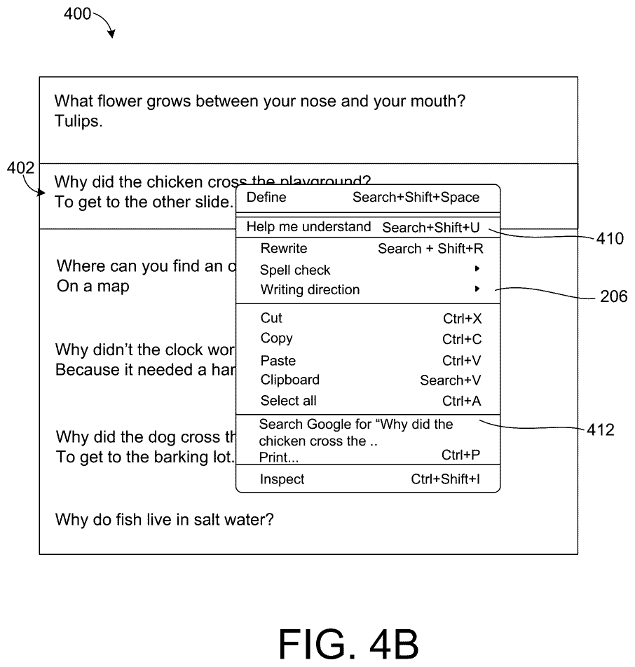

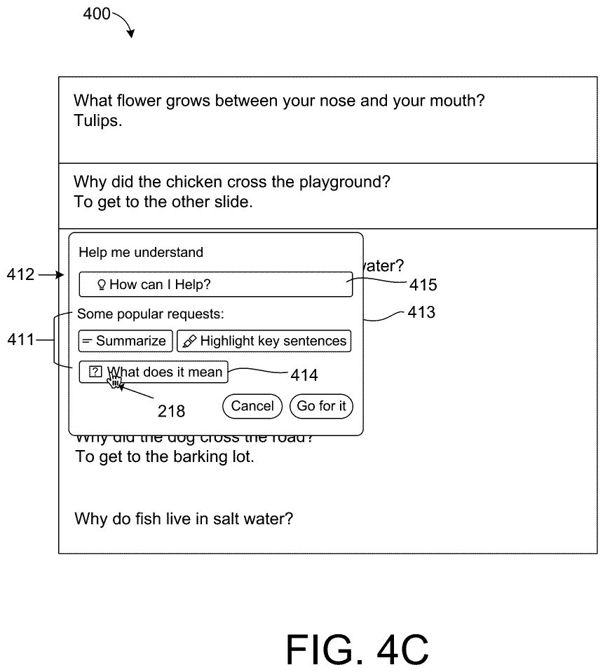

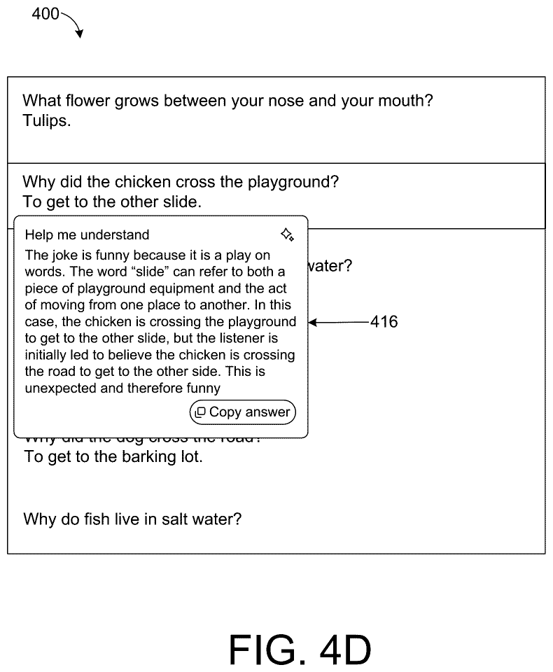

In an example, the prompt generator 216 may offer a prompt to provide further context or background or explanations for selected content. For example, FIG. 4A depicts a browser window 400 displaying a URL with a list of riddle questions with respective answers. In the example, the user may hover a mouse 404 over a riddle while right clicking to select a selected content 402. In examples, the text in the window 400 may be editable or read only. In examples, the text may represent a portion of a larger document.

FIG. 4B depicts the menu 106, which includes a help me understand explanation option 410. The help me understand explanation option 410 may be selected to provide further background or context for content on the riddle. In some examples, the explanation option 410 may be used to provide interpretive explanations that go beyond a definition or an encyclopedia-type background. In some examples, the help me understand explanation option 410 may provide further background about the relationship of ideas in the selected content 402 or how concepts like irony or sarcasm relate to the selected content 402.

FIG. 4C depicts a further menu 413 that may appear upon selecting the help me understand explanation option 410. The further menu 413 may include a user interface element for receiving a prompt from the user, i.e., text prompt field 415, along with a prompts related to the set of explanation prompts 411. In the example, the set of explanation prompts 411 section surfaces prompts that are more specific to providing context or background for content, such as “Summarize”, “Highlight key sentences”, and “What does it mean.”

Returning to FIG. 4B, it may be seen that the menu 106 may provide a web query option 412 for the selected content 402.

In an example, the prompt generator 216 may execute on the device 201 or, on the server 250. With user consent, information (e.g., selected content 102) may be sent from the device 201 to the server 250 to generate one or more prompts. In an example, the prompt generator 216 may execute a model with any of the factors described above as inputs to generate a prompt for display, for example in the menu 106 or the further menu 108.

In examples, the processor 202 may further include the language model 218. The language model access module 218 may receive the window context determined with content and context selector 214 and the prompt determined using the prompt generator 216 to generate an output. In examples, the language model 218 may execute as part of a library, accessible to multiple applications. In further examples, the language model 218 may be integrated into an executable application.

The language model 218 may be trained on a broad set of data. In examples, the training data may include text and/or images extracted from webpages and other publications. In examples, the language model 218 may be optimized to execute on the device 201.

In examples, the language model 218 may execute on the server 250. With user consent, the prompt and window context may be sent to the server 250, which may respond by sending an output to the device 201.

In an example, the processor 202 may further include the re-write module 220. In examples, the re-write module 220 may initiate the execution of the prompt generator 216, the language model 218, and the re-write module 220. In examples, the re-write module 220 may display one or more outputs from the re-write module 220. In an example, the re-write module 220 may be accessible via the operating system for any application executing via one or more API calls.

Menu 106 of FIG. 1A, menu 108 of FIG. 1B, and menu 413 of FIG. 4C are examples of menus that may be displayed by the re-write module 220. In examples, menus 106, 108, and 413 may be displayed upon right clicking selected content 402. In examples, menu 106 may be displayed automatically upon a long press of selected content 102. Menu 106 may be displayed in response to any action that triggers a pop-up menu.

Returning to FIG. 1B, a cursor 118 is depicted hovering over a selected prompt 120, “Formalize”. Upon selection of the formalize prompt 120 from the further menu 108, an output window 130 may be displayed, as depicted in FIG. 1C.

The output window 130 may have a title 132. In examples, the title 132 may provide background for any combination of the selected content 102, the window context, and the selected prompt. In the example the title 132 is, “Here are a few more formal ways to say, “Have a great weekend!”

The output window 130 may display one or more outputs from the language model 218. In an example the output window 130 may be a popup window displayed over application window 100. In the example, the output window 130 displays three selectable outputs from the re-write module 220: respective outputs 134A, 134B, and 134C. In an example, each of the respective outputs 134A, 134B, and 134C may be generated based on the same window context and prompt. The output window 130 may include any number of respective outputs.

Receiving an indication that one of the respective outputs 134A, 134B, and 134C was selected may cause the system to copy the output onto a clipboard. Receiving an indication that an output was selected may further cause the system to automatically replace selected content 102 in editable application window 100 with the selected output. For example, in FIG. 1C the cursor 118 selects the output 134A. Turning to FIG. 1D, the content of output 134A is pasted into the application window 100 replacing the selected content 102, “I hope you have a wonderful weekend filled with rest, relaxation, and fun!”

In an example, in response to receiving an indication that one of outputs 134A, 134B, and 134C were selected, a further prompt may be displayed. The further prompt may be operable to generate a further output based on the first output and the second prompt as input to the language model. The steps of selecting content with the context selector 214, providing a prompt with the prompt generator 216, generating an output with the language model 218, and displaying the output with one of the re-write module 220 or explanation module 222, may be repeated as many times as desired to help a user further iterate or refine an output from the language model 218.

In an example, upon receiving a selection of an output, for example one of respective outputs 134A, 134B, and 134C, a further prompt may be displayed which is operable to generate a further output based on the selected output and the further prompt.

In an example the output may be generated using the selected content 102 associated with a first application and the context associated in a second application as inputs. For example, a user may select text as the selected content 102 in a first application (including a first tab of a web browser) that is a word processer, which may relate to a painting. In a web browser, the second application (including another tab of the web browser), an image of a painting may be displayed. The operating system may have access to such additional context where an application executing within the operating system does not. The output generated by the language model may use the context of the image of the painting (e.g., in the second application/tab) when generating a text description of a painting.

In an example, the processor 202 may further include the explanation module 222. The explanation module 222 may be used to provide a further explanation of a concept expressed in the selected content 402. The explanation module 222 may generate an explanation by providing the context selector 214, the prompt generator 216, and the language model 218 as inputs to the language model 218. In examples, the explanation module 222 may be accessible via the operating system for any application executing via one or more API calls.

Returning to the example of FIG. 3B, it may be seen that upon selecting the selected content 302 and the define prompt 310, the explanation module 222 may display definition output window 312 over the word processing application window 300. The definition output window 312 may further display a copy answer option 314. Upon selecting the copy answer option 314, the user may be able to copy the content of definition output window 312 to the clipboard for pasting elsewhere.

In examples, the selected content 302 may include a term with multiple meanings and the explanation provided in the definition output window 312 may be related to one meaning of the multiple meanings based on the context. For example, selected content 302 includes the term “L/R”, which may have multiple meanings, such as L/R polarization filter, a living room in a real estate context, or lawrencium, a synthetic chemical element. The window context around the selected content 302 in word processing application window 300 includes the unselected text, “None of the light will get through: the first filter removes all of the [L/R] components of the light, and the second filter removes . . . .” Using at least a portion of the unselected text in word processing application window 300 as input to the language model 218 may provide an explanation specific to the L/R polarization filter. Thus, the context (in this case the unselected text) helps the model focus on generating a specific definition rather than covering all possible definitions. This is accomplished with less input from the user.

FIG. 4D illustrates that upon selecting the selected content 402 and the explanation option 410 (labeled “Help me understand” in FIG. 4D), the explanation module 222 may depict an output window 416 displaying the output from the language model 218 based on providing the selected content 402 and the explanation option (e.g., “Help me understand” prompt) as inputs.

In an example, the explanation module 222 may receive the selected content 402, which may initiate the display of an option to generate an explanation of the selected content 402, such as the explanation option 410. Upon selection of the explanation option 410, the explanation module 222 may provide and/or display prompts related to providing explanations for the selected content 402. Example prompts may include, “Summarize”, “Highlight key sentences”, or “What does it mean?”. Upon receiving a selected prompt 414, the explanation module 222 may generate an explanation using the selected content 402 and selected prompt 414 as inputs. The explanation may be displayed in the output window 416.

In an example, the explanation may describe a relationship between a first phrase and a second phrase in the selection of content. For example, the selected content 402 includes the phrase, “why did the chicken cross the road” and “to get to the other slide”. The explanation in the output window 416 explains the relationship between the two phrases as being unexpected and funny because the user expects the term, ‘side’ and not ‘slide’. In an example, the unselected text of the browser window 400 may be used as context for the selected text. Because the unelected content relates to jokes, this context helps the model provide a better explanation.

In an example, the explanation generated by the language model 218 may use the selected prompt 414 from the set of explanation prompts 411 as an input. In an example, the explanation may be based on the selection of content 402, the selected prompt 414 of the set of explanation prompts 411, and window context relating to the selection. In an example, the explanation module 222 may provide a user interface element, i.e., text prompt field 415, configured to receive a prompt from a user, wherein the prompt received in the text prompt field 415 is one of the prompts provided by the explanation module 222.

In examples, the re-write module 220 and the explanation module 222 may be capable of communicating with more than one language model. For example, certain prompts or certain types of selected content may result in the system sending the prompt and window context to a different language model (e.g., a translate model, a rewrite model, a definition model). Other factors used by the re-write module 220 to select a model may include the type of prompt selected, window context, operating system signals, etc. In some implementations, just a single language model may be used.

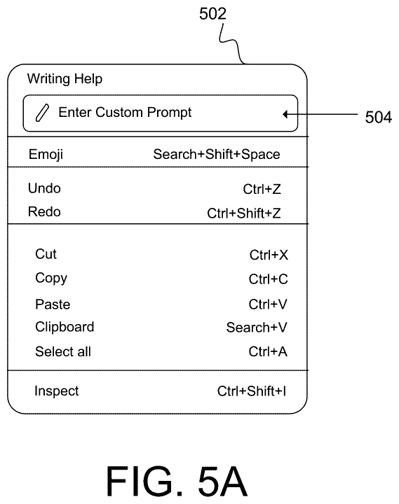

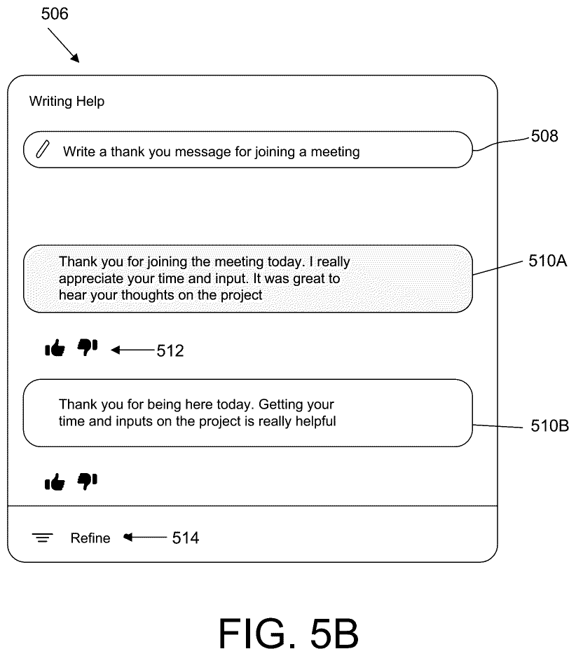

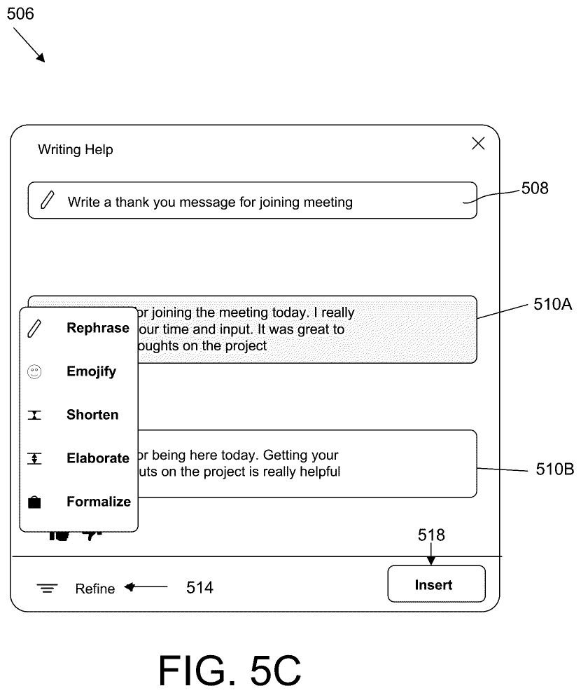

FIGS. 5A-5C depict a feature that allows a user to get help writing or creating content that is not based on selected content. In an example, a menu 502 may appear upon right clicking or hovering over an editable space within an application window with no highlighted content.

The menu 502 may include a custom writing prompt option 504. Upon selection of the custom writing prompt option 504, a writing help menu 506 may be displayed. Turning to FIG. 5B, an example implementation of the writing help menu 506 is depicted. The writing help menu 506 may include a prompt field 508 where a user may type a custom prompt to write something. For example, in FIG. 5B a user has prompted, “Write a thank you message for joining a meeting.”

In an example, the re-write module 220 may send the prompt from the prompt field 508 and window context to the language model 218 to generate an output. With user consent, the window context for help me write may include the type of application that writing help menu 506 is displayed in, other applications executing on the device 201, or content from other applications executing on the device 201.

Returning to FIG. 5B, it may be seen that one or more outputs 510A, 510B from the language model 218 may be displayed. In an example, accept or decline options 512 (depicted as a thumbs up and thumbs down in the figure) may be displayed with each respective output 510A, 510B. Upon selecting an accept option, the respective output may be copied into an editable field. Upon selecting the decline option, the respective output may disappear from the display. In examples, a new output may be displayed in its place.

In an example, the writing help menu 506 may include further prompts to revise the output. In an example, the further prompts to re-write one or more outputs may be accessed by selecting a refine option 514. FIG. 5C depicts a refine option 514 that may be generated to display further prompts to revise the one or more outputs upon selection. The prompts displayed in the refine option 514 may be selected via any of the methods described with respect to the prompt generator 216 above. Alternatively, the outputs may be further revised by entering a prompt into the prompt field 508.

Upon selecting an output, via either clicking on one of the outputs 510A, 510B or selecting one of the accept or decline options 512 accept options, the selected output may be pasted into the editable field where the menu 502 was first accessed, for example via insert option 518.

In an example, a user may write an email in an email application. In the background, the processor 202 may be executing other applications, such as an image editing application with an image file may be open. The user may initiate requesting help writing a message from an email application by right clicking a window of the email application with no text selected.

In an example, a prompt may be displayed to write a description of the image. The image may be used as an input to the language model 218 along with the prompt to generate the output, or description of the image.

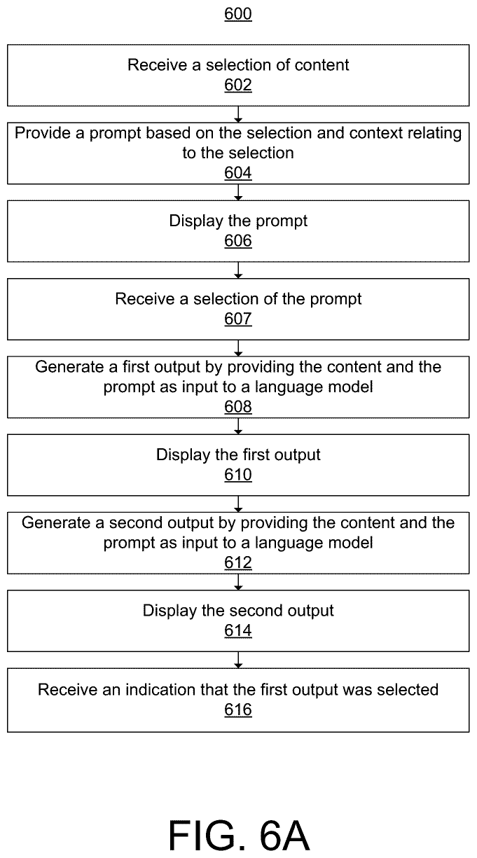

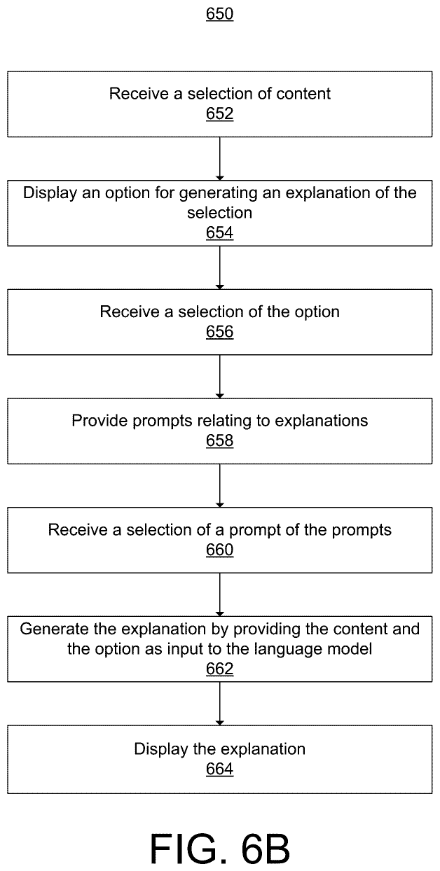

FIG. 6A depicts method 600, in accordance with an example. Method 600 may be used within an application to generate an output (for example, new content, modified content, or information about content displayed in a window) based on the content in a window using a language model.

In examples, method 600 may be executed to provide an improved language model output, according to an example. Method 600 may include any combination of steps 602-616.

Method 600 may begin with step 602. In step 602, selected content may be received from content displayed in a window. For example, selected content may be received from content and context selector 214, as described above.

Method 600 may continue with step 604. In step 604, a prompt may be generated based on the selection and context from the window. For example, the prompt may be generated as described in the prompt generator 216 above.

Method 600 may continue with step 606. In step 606, a prompt may be displayed. For example, the prompt suggestion section 112 is displayed in FIG. 1B, as described above.

Method 600 may continue with step 607. In step 607, a prompt selection may be received. For example, the prompt selection may be received as described in the prompt generator 216 above.

Method 600 may continue with step 608. In step 608, a first output may be generated by providing the content and the prompt as input to a language model. For example, the language model 218 may generate an output, as described above.

Method 600 may continue with step 610. In step 610, the first output may be displayed. For example, the output may be displayed as described in re-write module 220 above.

Method 600 may continue with step 612. In step 612, a second output may be generated by providing the content and the prompt as input to a language model. For example, the language model 218 may generate an output, as described above.

Method 600 may continue with step 614. In step 614, the second output may be displayed. For example, the output may be displayed as described in re-write module 220 above.

Method 600 may continue with step 616. In step 616, an indication may be received that the first output was selected. For example, the indication may be received as described in re-write module 220 above.

In examples, steps 604-616 may be repeated any number of times to iterate the output. In this way, a user may continue to refine content using method 600 and gain the full productivity benefits offered by a language model.

FIG. 6B depicts method 650, in accordance with an example. Method 650 may be used within an application to generate an output including an explanation of selected content in a window (e.g., a definition, a background description, a description comparing the selected content to another concept) using a language model.

Method 650 may begin with step 652. In step 652, a selection of content may be received from a window. For example, selected content may be received from content and context selector 214, as described above.

Method 650 may continue with step 654. In step 654, an option for generating an explanation of the selection may be displayed. For example, the menu 106 including the explanation option 410 may be displayed, as described above.

Method 650 may continue with step 656. In step 656, a selection of the option may be received. For example, a user may select the explanation option 410, as described above.

Method 650 may continue with step 658. In step 658, prompts relating to explanations may be provided. For example, the further menu 413 including the text prompt field 415 and the set of explanation prompts 411 may be displayed, as described above.

Method 650 may continue with step 660. In step 660, a selection of the prompts may be received. For example, a user may select the selected prompt 414, as described above.

Method 650 may continue with step 662. In step 662, the explanation using a language model based on the content, and the prompt may be generated. For example, the interactive content application 212 may execute the language model 218, as described above.

Method 650 may continue with step 664. In step 664, the explanation may be displayed. For example, the output window 416 may be displayed, as described above.

By providing access to a language model from within an application window 100, a user may receive information that is more relevant to their needs because it will be generated in view of the context of application window 100. In examples, any combination of steps relating to methods 600 and/or 650 may be implemented in a browser application programming interface (API), via a browser plug in, or via an operating system API. This may allow the developer of any web or desktop application to integrate language model capabilities into their application. This may allow users to access language model output information with fewer inputs or actions on their behalf to get the answers they are looking for, providing a more streamlined and accessible experience.

The present disclosure describes improved capabilities that may be implemented at the operating system level. This may provide improved functionality that can be consistent across applications/user interfaces and context and ranking signals may be available to the operating system that are not available to an application/extension.

By allowing a user to generate prompts relating to selected content, generate a language model output, and display that output, more relevant information may be provided to a user more easily without needing to switch between multiple applications.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a method, wherein the context relating to the content includes data available to an operating system executing on a user device.

In some aspects, the techniques described herein relate to a method, wherein the selection is related to a first application and the context relating to the selection relates to a second application.

In some aspects, the techniques described herein relate to a method, wherein the selection is related to a first application and generating the output further includes using content relating to a second application as input to the language model.

In some aspects, the techniques described herein relate to a method wherein the selection is editable and the output is replacement content for the selection.

In some aspects, the techniques described herein relate to a method to 5, wherein the prompt is further generated based on a popularity of the prompt given the context.

In some aspects, the techniques described herein relate to a method to 6 wherein the context relates to an application associated with the selection.

In some aspects, the techniques described herein relate to a method to 7, wherein the output is a revised version of the selection generated based on the content and the prompt.

In some aspects, the techniques described herein relate to a method to 8, wherein the output is a first output, and wherein the language model further generates a second output by providing the content and the prompt as input to the language model, and the method further includes: displaying the second output with the first output, wherein the first output and the second output are selectable by a user, and wherein the first output is selected by the user.

In some aspects, the techniques described herein relate to a method to 9, wherein the prompt is a first prompt, the output is a first output, and the method further includes: receiving an indication that the first output was selected; and in response to receiving the indication, displaying a second prompt operable to generate a second output based on the first output and the second prompt as input to the language model.

In some aspects, the techniques described herein relate to a method, further including: receiving a selection of the second prompt; and generating the second output by providing the first output and the second prompt as input to the language model.

In some aspects, the techniques described herein relate to a method to 11, wherein the language model executes on a user device.

In some aspects, the techniques described herein relate to a method, wherein the explanation is further generated using context relating to the selection as input to the language model.

In some aspects, the techniques described herein relate to a method, wherein the context includes data available to an operating system executing on a user device.

In some aspects, the techniques described herein relate to a method to 15, wherein the context includes additional content displayed in an application outside the selection of content.

In some aspects, the techniques described herein relate to a method, wherein the selection of content includes a term with multiple meanings and the explanation is related to one meaning of the multiple meanings based on the context.

In some aspects, the techniques described herein relate to a method to 17, wherein the explanation relates to a definition of the selection.

In some aspects, the techniques described herein relate to a method to 16, wherein the explanation describes a relationship between a first phrase and a second phrase in the selection of content.

In some aspects, the techniques described herein relate to a method to 19, wherein the selection of content is read-only content.

In some aspects, the techniques described herein relate to a method to 19, further including: receiving a selection of the option; providing prompts relating to explanations; and receiving a selection of a prompt of the prompts, wherein the explanation is based on the prompt of the prompts and the selection.

In some aspects, the techniques described herein relate to a method, wherein the explanation is based on the selection of content, the prompt of the prompts, and context relating to the selection.

In some aspects, the techniques described herein relate to a method, wherein providing prompts relating to explanations includes providing a user interface element for receiving a text prompt from a user, wherein the text prompt is one of the prompts.

In some aspects, the techniques described herein relate to a system, wherein the context relating to the content includes data available to an operating system executing on a user device.

In some aspects, the techniques described herein relate to a system, wherein the selection is editable and the output is replacement content for the selection.

In some aspects, the techniques described herein relate to a system, wherein the language model executes on a user device.

In some aspects, the techniques described herein relate to a system, wherein generating the explanation further includes using context relating to the selection as an input, the context including data available to an operating system executing on a user device.

In some aspects, the techniques described herein relate to a system to 29, wherein the explanation is further generated using context relating to the selection as input.

What is claimed is:

1. A method comprising:
receiving a selection of content;
in response to receiving the selection, providing a prompt based on the selection and context relating to the selection;
displaying the prompt;
in response to receiving a selection of the prompt, generating output by providing the content and the prompt as input to a language model; and
displaying the output.

2. The method of claim 1, wherein the context relating to the content includes data available to an operating system executing on a user device.

3. The method of claim 1, wherein the selection is related to a first application and the context relating to the selection relates to a second application.

4. The method of claim 1, wherein the selection is related to a first application and generating the output further includes using content relating to a second application as input to the language model.

5. The method of claim 1, wherein the selection is editable and the output is replacement content for the selection.

6. The method of claim 1, wherein the prompt is further generated based on a popularity of the prompt given the context.

7. The method of claim 1 wherein the context relates to an application associated with the selection.

8. The method of claim 1, wherein the output is a revised version of the selection generated based on the content and the prompt.

9. The method of claim 1, wherein the output is a first output, and wherein the language model further generates a second output by providing the content and the prompt as input to the language model, and the method further comprises:
displaying the second output with the first output,
wherein the first output and the second output are selectable by a user, and
wherein the first output is selected by the user.

10. The method of claim 1, wherein the prompt is a first prompt, the output is a first output, and the method further comprises:
receiving an indication that the first output was selected; and
in response to receiving the indication, displaying a second prompt operable to generate a second output based on the first output and the second prompt as input to the language model.

11. The method of claim 10, further comprising:
receiving a selection of the second prompt; and
generating the second output by providing the first output and the second prompt as input to the language model.

12. The method of claim 1, wherein the language model executes on a user device.

13. A method comprising:
receiving a selection of content;
in response to receiving the selection of the content, displaying an option for generating an explanation of the selection;
generating the explanation by providing the selection of content and the option as input to a language model; and
displaying the explanation.

14. The method of claim 13, wherein the explanation is further generated using context relating to the selection as input to the language model.

15. The method of claim 14, wherein the context includes data available to an operating system executing on a user device.

16. The method of claim 14, wherein the context includes additional content displayed in an application outside the selection of content.

17. The method of claim 14, wherein the selection of content includes a term with multiple meanings and the explanation is related to one meaning of the multiple meanings based on the context.

18. The method of claim 14, wherein the explanation relates to a definition of the selection.

19. The method of claim 13, wherein the explanation describes a relationship between a first phrase and a second phrase in the selection of content.

20. The method of claim 13, wherein the selection of content is read-only content.

21. The method of claim 13, further comprising:
receiving a selection of the option;
providing prompts relating to explanations; and
receiving a selection of a prompt of the prompts,
wherein the explanation is based on the prompt of the prompts and the selection.

22. The method of claim 21, wherein the explanation is based on the selection of content, the prompt of the prompts, and context relating to the selection.

23. The method of claim 21, wherein providing prompts relating to explanations includes providing a user interface element for receiving a text prompt from a user, wherein the text prompt is one of the prompts.

24. A system comprising:
a processor; and
a memory configured with instructions to:
receive a selection of content;
in response to receiving the selection, provide a prompt based on the selection and context relating to the selection;
display the prompt;
in response to receiving a selection of the prompt, generate output by providing the content and the prompt as input to a language model; and
display the output.

25. The system of claim 24, wherein the context relating to the content includes data available to an operating system executing on a user device.

26. The system of claim 24, wherein the selection is editable and the output is replacement content for the selection.

27. The system of claim 24, wherein the language model executes on a user device.

28. A system comprising:
a processor; and
a memory configured with instructions to:
receive a selection of content;
in response to receiving the selection of the content, display an option for generating an explanation of the selection;
generate the explanation by providing the selection of content and the option as input to a language model; and
display the explanation.

29. The system of claim 28, wherein generating the explanation further includes using context relating to the selection as an input, the context including data available to an operating system executing on a user device.

30. The system of claim 28, wherein the explanation is further generated using context relating to the selection as input.

31. A computing device, comprising:
at least one processor; and
a non-transitory computer-readable medium storing executable instructions that, when executed by the at least one processor, cause the computing device to:
receive a selection of content;
in response to receiving the selection, provide a prompt based on the selection and context relating to the selection;
display the prompt;
in response to receiving a selection of the prompt, generate output by providing the content and the prompt as input to a language model; and
display the output.
